(19) United States
(12) Patent Application Publication
(10) Pub. No.: US 2020/0190222 A1
(43) Pub. Date: Jun. 18, 2020

(54) DEGRADED HYDROXYALKYLATED STARCHES AND METHODS OF PREPARATION

(71) Applicants: Kansas State University Research Foundation, Manhattan, KS (US); Sappi North America, Inc., Boston, MA (US)

(72) Inventors: Yong-Cheng Shi, Manhattan, KS (US); Joseph M. Fernandez, Buxton, ME (US); Arbin Rajbanshi, Gorham, ME (US); Qi Wang, Gorham, ME (US); Zhenhua Sun, Manhattan, KS (US)

(21) Appl. No.: 16/220,578

(22) Filed: Dec. 14, 2018

(51) Int. Cl. C08B 30/12; C08B 31/12

(52) U.S. Cl. CPC C08B 30/12; C12Y 302/01001; C08B 31/12

(57) ABSTRACT

Degraded hydroxyalkylated starches and methods of preparing the same from waxy, normal, or modified starches are provided. The starches can be prepared by several approaches that involve acid or enzyme degrading either before or after starch modification with an alkylene oxide. The modified and degraded starches exhibit improved swelling characteristics, solution stability of cooked starch, improved film-forming properties and/or improved coating performance. In addition, the degraded hydroxyalkylated starches can be used as a fat replacement in foods, in film-forming compositions, in coating compositions, and to encapsulate other materials.

### BACKGROUND OF THE INVENTION

The present invention is generally directed toward hydroxyalkylated degraded starches and methods of preparing the same from waxy and normal starches. The modified and degraded starches can be prepared according to any of several approaches that involve acid or enzyme degrading either before or after starch modification with propylene oxide (PO).

In certain embodiments, the hydroxyalkylation of the degraded starch may improve the swelling characteristics of the starch granules, which is especially important in food applications, such as use as a fat replacement. The hydroxyalkylation of the degraded starch may also improve solution stability of cooked starch, improve film forming properties of the starch, and/or improve coating performance of the starch. The degraded hydroxyalkylated starches also can be used in film forming compositions, in coating compositions, and to encapsulate other materials.

### SUMMARY OF THE INVENTION

According to one embodiment of the present invention there is provided a method of acid degrading and hydroxyalkylating starch molecules. In one particular embodiment, a degraded starch is provided and then reacted with an alkylene oxide, such as propylene oxide. For example, granular starch is suspended in an aqueous slurry and then degraded by reacting the starch slurry with a strong acid, such as hydrochloric acid, for a sufficient period of time so as to cleave alpha-1,4 and/or alpha-1,6 glycosidic linkages within the starch to a desired level. The reacted starch slurry is then neutralized, and the degraded starch washed. The degraded starch is re-suspended in an aqueous slurry and reacted with an alkylene oxide under basic conditions. The reaction with the alkylene oxide causes substitution of hydroxyalkyl groups onto the starch molecule. The hydroxyalkylated starch is then recovered from the slurry.

According to another embodiment of the present invention there is provided a method of hydroxyalkylating and acid degrading starch molecules. Granular starch is suspended in an aqueous slurry and reacted with an alkylene oxide under basic conditions so as to cause substitution of hydroxyalkyl groups onto the starch molecule. After the reaction has progressed to the desired level, the slurry is neutralized, and the modified starch washed. Then, the washed starch is re-suspended in an aqueous slurry and reacted with a strong acid, such as hydrochloric acid, for a sufficient period of time so as to cleave alpha-1,4 and or alpha-1,6 glycosidic linkages within the starch to a desired level. The degraded starch is then recovered from the slurry.

According to still another embodiment of the present invention there is provided a method of hydroxyalkylating and enzyme degrading starch molecules. Granular starch is suspended in an aqueous slurry and reacted with an alkylene oxide under basic conditions so as to cause substitution of hydroxyalkyl groups onto the starch molecule. After the reaction has progressed to the desired level, the slurry is neutralized, and the modified starch washed. Then, the washed starch is re-suspended in an aqueous slurry and treated with α-amylase for a sufficient period of time so as to cleave alpha-1,4 glycosidic linkages within the starch to a desired level. The enzyme is then deactivated, and the degraded, hydroxyalkylated starch is recovered.

Embodiments of the present invention are also directed toward starch that is produced according to any of the methods described herein. In addition, embodiments of the present invention are directed toward a modified starch product comprising a degraded and hydroxyalkylated starch, wherein the starch has a degree of substitution (hydroxyalkylation) of from about 0.05 to about 0.30. In addition, the starch, when dispersed in an aqueous slurry at a 10% solids content, has a Brookfield viscosity at 25° C. and 100 rpm of from about 3 cp to about 100 cp.

### BRIEF DESCRIPTION OF THE DRAWINGS

FIG. 1 is a chart showing molecular size distribution for various PO-modified and degraded starches made in accordance with the present invention; and

FIG. 2 contains process flow diagrams for three approaches of forming PO-modified and degraded starches in accordance with the present invention.

### DETAILED DESCRIPTION OF THE PREFERRED EMBODIMENT

Hydroxyalkylated starches, and especially hydroxypropylated starches, tend to have high viscosities in low solids-content dispersions. This characteristic has made hydroxypropylated starches suitable for use as emulsifiers, stabilizers, and thickeners in food and cosmetic products and for fluid-loss control in drilling muds, drill-in, completion and workover fluids in downhole applications. However, this viscosity-enhancing characteristic is not suitable for many applications due to its poor film-forming properties and poor coating performance. Embodiments of the present invention seek to solve these performance characteristics by reducing the molecular weight of the hydroxyalkylated starch, achieve solution stability, good film-forming qualities and improved coating performance.

The starches that may be modified according to methods of the present invention include various native starches that may be derived from any starch sources, such as waxy and normal starches from wheat, maize, potato, tapioca, rice, sorghum, peas, chickpeas and the like. As used herein, the term “normal starch” refers to starches that are non-waxy and non-high amylose starches. In certain embodiments, the starch can be a native waxy starch. As used herein, a “waxy starch” refers to a starch material that is high in amylopectin. In certain embodiments, a waxy starch has an amylopectin content of greater than 90% by weight, and preferably greater than 95%, or even 99%, amylopectin. In these embodiments, the starch source is a highly branched form of starch comprising both alpha-1,4 and alpha-1,6 glycosidic linkages. It is also within the scope of the present invention to utilize as a starting starch material, starches that have been debranches, such as through treatment with isoamylase, or otherwise modified from its native form. A debranched starch will be high in amylose and comprise primarily alpha-1,4 glycosidic linkages.

The present invention contemplates at least three different approaches to hydroxyalkyl substitution and degradation of the starting starch molecules. Two of these approaches involve acid conversion or hydrolysis of the starch molecules, and one approach utilizes enzymatic hydrolysis. Moreover, in certain embodiments, the hydroxyalkyl substitution may occur prior or after starch degradation.

The acid conversion step cleaves starch molecules, and as a result, reduces molecular weight of starch and the viscosity of cooked starch. The acid cleaves both alpha-1,4 and alpha-1,6 bonds in starch molecules. However, in embodiments in which starch granules are used as the starting starch material, the acid hydrolysis tends to occur mainly in the amorphous regions of the starch granules. Hydrochloric acid is a preferred acid for carrying out the acid conversion of starch.

To begin the acid conversion, the starch, which may or may not have already undergone hydroxyalkylation, is dispersed in an aqueous slurry. In certain embodiments, the solids content of the starch slurry is at least 10%, at least 15%, at least 20%, at least 25%, at least 30%, or at least 35% by weight, but less than 70%, less than 65%, less than 60%, less than 55%, less than 50%, or less than 45% by weight. Preferably, the solids content of the starch slurry is about 40% by weight.

The acid is added to the slurry in an amount of from about 1.5% to about 7.5% by weight, or from about 3% to about 6% by weight, based on the solids content of the slurry. In certain embodiments, the acid conversion is carried out under mildly-elevated temperature conditions, close to the gelatinization temperature of the starch, preferably from about 25° C. to about 75° C., or from about 30° C. to about 70° C., or from about 35° C. to about 65° C. Most preferably the acid conversion is carried out at a temperature of about 40-50° C. In certain embodiments, the acid conversion process is carried out at temperatures that are less than the gelatinization of the starch to avoid the swelling of the starch granules. If the starch granules swell during this step, recovery of the acid-converted starch, particularly via a filtration process, would be difficult. The acid conversion is preferably carried out for a period of about 6 to about 18 hours. After acid conversion, the solution is neutralized to pH of about 6 by addition of a base, such as sodium hydroxide.

The enzymatic hydrolysis is preferably carried out with alpha-amylase. Alpha-amylase cleaves only alpha-1,4 linkages in starch molecules, but not alpha-1,6 linkages. Therefore, the starch prepared with enzymatic hydrolysis as a part of the approach will have different molecular configurations than if acid conversion was used. In certain embodiments, alpha-amylase is added to the starch slurry in an amount of from about 0.01% to about 1%, from about 0.05% to about 0.5%, or from about 0.1% to about 0.25%, based upon the dry weight of the starch in the slurry. In particular embodiments, if a waxy starch is selected, a greater amount of alpha-amylase may be used compared to the same amount of a normal starch. In certain embodiments, the alpha-amylase acts upon the starch at higher temperatures than compared to the acid conversion process. In certain embodiments, the enzymatic hydrolysis is conducted at a slurry temperature of from about 65° C. to about 90° C., or from about 70° C. to about 85° C., or preferably about 80° C. Thus, unlike the acid-conversion process, the starch undergoing enzymatic hydrolysis tends to be gelatinized. Starch gelatinization is a process of breaking down the intermolecular bonds of starch molecules in the presence of water and heat, allowing the hydrogen bonding sites (the hydroxyl and oxygen) to engage more water. This irreversibly dissolves the starch granule in water. Therefore, in contrast to certain embodiments of the acid conversion process, the starch undergoing enzymatic hydrolysis is gelatinized and cleavage of the alpha-1,4 glycoside linkages is not confined to the amorphous regions. The alpha-amylase cleaves alpha-1,4 glycoside linkages throughout the whole gelatinized starch molecules. The enzymatic hydrolysis is preferably carried out until the starch slurry exhibits desired viscosity characteristics, e.g., Brookfield viscosity at 100 rpm spindle speed, at 25° C., <10 cp at 10% solids.

It is also within the scope of the invention to form hydroxyalkylated starches using previously-modified starches as a starting material as opposed to native starches. The previously modified starch can be a previously-degraded starch or an oxidized starch. Alternate methods of degradation can be employed to form the degraded starch. For example, the starch may be degraded by dextrinization (treatment with heat and/or acid in a dry, non-slurried state) or oxidation.

The reaction of the degraded or non-degraded starch molecules with the alkylene oxide is also conducted in an aqueous slurry. In certain embodiments, the solids content of the starch slurry is at least 10%, at least 15%, at least 20%, at least 25%, at least 30%, or at least 35% by weight, but less than 70%, less than 65%, less than 60%, less than 55%, less than 50%, or less than 45% by weight. Preferably, the solids content of the starch slurry is about 40% by weight.

A quantity of sodium sulfate can be added to the starch slurry. Sodium sulfate is primarily used during starch modification to prevent premature swelling or gelatinization of the starch when temperature and pH are increased as a part of the modification process. In certain embodiments, the sodium sulfate is added to the starch slurry in an amount of from about 1% to about 25% by weight, from about 5% to about 20% by weight, or from about 7.5% to about 15% by weight, based on the solids content of the slurry. Preferably, the sodium sulfate is present at a level of about 10% by weight.

Next, the pH of the starch slurry is adjusted to alkaline levels, preferably from pH of about 10 to about 12, most preferably about 11. Any base may be used. Sodium hydroxide is a preferred pH adjusting agent.

An alkylene oxide is then added to the slurry. In preferred embodiments, the alkylene oxide is selected from the group consisting of ethylene oxide, propylene oxide, and butylene oxide, with propylene oxide being most preferred. In certain embodiments, the alkylene oxide is added at a level of from about 1% to about 25% by weight, or from about 5% to about 20% by weight, or from about 7.5% to about 15% by weight, based on the solids content of the slurry. Preferably, the alkylene oxide is present at a level of about 10% by weight.

The reaction between the alkylene oxide and starch in the slurry is carried out at a temperature close to the gelatinization temperature of the starch, but preferably not exceeding the gelatinization temperature of the starch. In certain embodiments, the reaction is carried out at a temperature of from about 25° C. to about 75° C., or from about 30° C. to about 70° C., or from about 35° C. to about 65° C. Most preferably the reaction with the alkylene oxide is carried out at a temperature of about 50° C. In certain embodiments, when a waxy starch is used, the reaction temperature with the alkylene oxide may be slightly lower than if a non-waxy starch is used. In this case, the preferred reaction temperature when using a waxy starch is about 43° C. The alkylene oxide reaction is carried out for a period of about 2 to about 36 hours, and preferably about 12-24 hours.

Following the reaction, the starch slurry is permitted to cool and is neutralized via addition of an acid, such as sulfuric acid, so that the slurry has a pH of from about 4.5 to about 7, or from about 5 to about 6, or about 5.5.

After each processing step, the starch can be filtered and washed, preferably more than once, to remove reagents that were added as a part of the reaction and/or hydrolysis steps. Finally, after each processing step, the starch may be dried by any means convention in the art. In certain embodiments, it is preferably to dry the alkylene oxide-modified starch and/or acid-converted starch using an oven operating at a temperature of from about 35° C. to 50° C., more preferably about 40° C. In certain embodiments, it is preferable to dry the enzymatically degraded starch using spray drying equipment, as the starch granules have been destroyed as a part of the enzymatic degrading process.

As stated previously, the degrading and hydroxyalkylation steps can be conducted in any order. However, it has been observed that ordering of these steps can affect the properties of the final starch product. For example, the acid conversion of the starch may occur prior to the reaction with the alkylene oxide or after. If the acid conversion step occurs first, the starch is capable of being degraded more than if the starch is degraded following the reaction with the alkylene oxide. Likewise, the enzymatic hydrolysis step may occur prior to reaction with the alkylene oxide or after. However, it is preferable that the enzymatic hydrolysis occur after reaction of the starch with the alkylene oxide so that unreacted alkylene oxide can be removed from the slurry by a filtration process.

As can be seen in the data presented in the Examples below, the distribution of the substituted group (e.g., the hydroxypropyl group) in the final starch products made by the approaches described herein would be different. The selection of which approach to utilize would be on the desired viscosity, solution stability, film forming properties, and coating performance for the starch material. It has been observed that when the propylene oxide is reacted with a granular starch, the hydroxypropylation occurred mainly in the amorphous regions of the starch granules. In addition, the selection of the starting base starch affects the final properties of the modified starch. For example, waxy corn starch produces better solution stability. However, normal has the advantage that it is generally a less expensive starting material.

The degraded hydroxyalkylated starch made according to certain embodiments of the present invention can be formed into slurries or otherwise dispersed into a liquid composition or carrier material. The resulting slurry or liquid composition may exhibit a relatively low viscosity making the slurry or composition very well suited for forming films or other coatings. As an objective measurement of this low-viscosity characteristic, certain embodiments of the present invention are directed toward a degraded hydroxyalkylated starch that when dispersed in water to form a slurry having a solids content of 10% by weight has a Brookfield viscosity at a spindle speed of 100 rpm of from about 2 to about 500 cps, from about 3 to about 100 cps, or from about 5 to about 50 cps at approximately 25° C. (i.e., room temperature). The viscosity measurements described herein are “cooked starch viscosity” measurements, which mean that the viscosity is measured after cooking a particular starch at 95-100° C. for 10 to 15 minutes followed by optional cooling of the starch to the indicated temperature of viscosity measurement.

In certain embodiments, the degraded hydroxyalkylated starch has a hydroxyalkyl group weight percentage of from about 1.5% to about 10%, from about 2% to about 8.5%, or from about 4% to about 7.5%. In certain embodiments, the degraded hydroxyalkylated starch has a degree of alkylene oxide substitution of from about 0.01 to about 0.4, or from about 0.05 to about 0.3, or from about 0.1 to about 0.25. In certain embodiments, the hydroxyalkylated starch has a number average molecular weight of from about 1,000 to about 150,000, from about 2,500 to about 125,000, or from about 5,000 to about 100,000. In certain embodiments, the hydroxyalkylated starch as a weight average molecular weight of from about 25,000 to about 750,000, from about 40,000 to about 675,000, or from about 50,000 to about 400,000. In certain embodiments, the hydroxyalkylated starch as a polydispersity of from about 1 to about 25, from about 2 to about 20, or from about 3 to about 15.

### EXAMPLES

The following examples set forth preferred materials and methods according to the present invention. These examples are provided by way of illustration and nothing therein should be taken as a limitation upon the overall scope of the invention. Although the examples describe the preparation and characterization of hydroxypropylated degraded starches, it is to be understood, however, that other alkylene oxides may be employed.

### Materials

Waxy and normal maize starches are manufactured by Tate & Lyle PLC (Decatur, Ill.). Ethylex® 2020 (a hydroxyethyl substituted starch derived from dent corn starch) is manufactured by Tate & Lyle PLC. Propylene oxide (PO) was purchased from Sigma-Aldrich (St. Louis, Mo.). α-amylase (BAN 480 L) was obtained from Novozymes North America (Franklinton, N.C.). Other chemicals were all analytical grade.

### Preparation of Degraded PO Starch

### Approach 1 (Acid Conversion+PO Reaction)

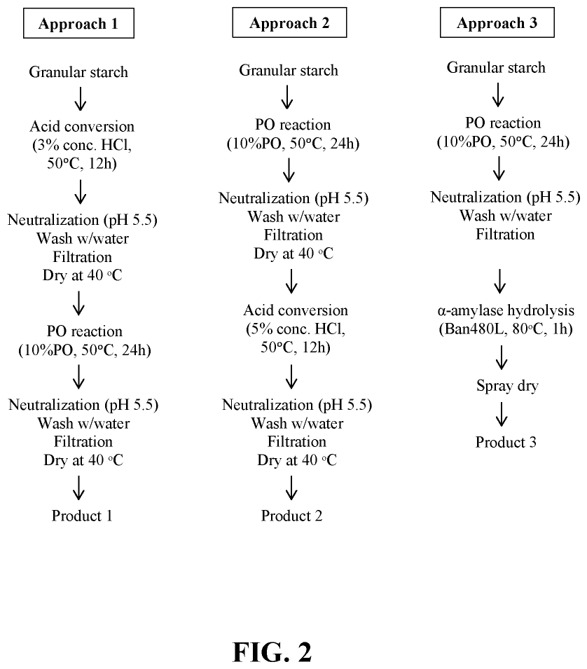

The preparation of degraded PO starches from approach 1 is shown in FIG. 2. The temperature of the water bath in which the acid conversion is to take place is set to 50° C. Corn starch (500 g) is slurried into 750 g water (40% solid content) in a beaker. The starch slurry is then transferred to a jar. The jar is placed in a water bath, stirred using an overhead mixer, and allowed to equilibrate to 50° C. Concentrated HCl (3%-6%, 15-30 g) is weighed and poured into the starch slurry, and permitted to react for 6-12 h. After 6-12 h, the pH is adjusted to 5.5 with 3% NaOH. The pH-adjusted mixture is then filtered. The retentate is re-suspended in 750 ml of water, and the suspension is then filtered. The washing and filtration is repeated. The starch is dried in an oven at 40° C.

A water bath in which the PO reaction is to occur is set to 45-50° C. for normal corn starch (43.5° C. for waxy corn starch). The acid-converted corn starch (360 g) is slurried into 540 g water (40% solid) in a beaker and stirred using an overhead mixer. Sodium sulfate (36 g, 10% based on the weight of the starch) is added, and the slurry mixed for 15 min. The pH is adjusted to 11.2 with 3% NaOH. The slurry is poured from the beaker into a glass jar with a lid. Propylene oxide (PO) (5-10% based on the weight of the starch) is weighed in a hood and added to the starch slurry. The jar is sealed immediately. The jar is shaken in the water bath at 45-50° C. (43.5° C. for waxy corn starch) for 24 h, after which it is allowed to cool to room temperature. The starch slurry is neutralized to pH 5.5 with 25% sulfuric acid. The slurry is filtered. The retentate is washed in 600 ml of water and filtered. The washing and filtration is repeated. The starch is dried in an oven at 40° C.

### Approach 2 (PO Reaction+Acid Conversion)

The preparation of degraded PO starches from approach 2 is shown in FIG. 2. The temperature of the water bath on which the propylene oxide reaction is to take place is set to 50° C. for normal corn starch (43.5° C. for waxy corn starch). The corn starch (360 g) is suspended into 540 g water (40% solid) in a beaker and stirred using an overhead mixer. Sodium sulfate (36 g, 10% based on the weight of the starch) is added to the slurry and mixed for 15 min. The pH is adjusted to 11.2 with 3% NaOH. The slurry is poured from the beaker into a glass jar with a lid. Propylene oxide (PO) (36 g, ˜43.4 mL, 10% based on the weight of the starch) is weighed in a hood and added to the starch slurry. The jar is sealed immediately and shaken in water bath at 50° C. (43.5° C. for waxy corn starch) for 24 h, after which it is allowed to cool to room temperature. The starch slurry is neutralized to pH 5.5 with 25% sulfuric acid. The slurry is filtered. The retentate is washed in 600 ml of water and then filtered. The washing and filtration is repeated. The starch is dried in an oven at 40° C.

The water bath in which acid conversion of the starch was to be performed was set to 40° C. The PO-modified corn starch (360 g) is slurried into 540 g water (40% solid content) in a beaker. The starch slurry is transferred into ajar. The jar is placed in a water bath, stirred using an overhead mixer, and allowed to equilibrate to 50° C. Concentrated HCl (5%-7.5%, 18-40.5 g) is weighed and poured into the starch slurry. The mixture is permitted to react for 10-18 h, after which the pH is adjusted to 5.5 with 3% NaOH. The mixture is then filtered. The retentate is re-suspended in 540 ml of water and filtered. The washing and filtration is repeated. The starch is then dried in an oven at 40° C.

### Approach 3 (PO Reaction+Enzyme Degradation)

The temperature of the water bath on which the propylene oxide reaction is to take place is set to 50° C. for normal corn starch (43.5° C. for waxy corn starch). The corn starch (360 g) is suspended into 540 g water (40% solid) in a beaker and stirred using an overhead mixer. Sodium sulfate (36 g, 10% based on the weight of the starch) is added to the slurry and mixed for 15 min. The pH is adjusted to 11.2 with 3% NaOH. The slurry is poured from the beaker into a glass jar with a lid. Propylene oxide (PO) (36 g, ˜43.4 mL, 10% based on the weight of the starch) is weighed in a hood and added to the starch slurry. The jar is sealed immediately and shaken in water bath at 50° C. (43.5° C. for waxy corn starch) for 24 h, after which it is allowed to cool to room temperature. The starch slurry is neutralized to pH 5.5 with 25% sulfuric acid. The slurry is filtered. The retentate is washed in 600 ml of water and then filtered. The washing and filtration is repeated. The starch cake is weighed, and the moisture content of the starch cake is measured. The cake is then put back into a slurry in distilled water (18-20% solid) in a metal jar and stirred by the overhead mixer.

The temperature of a water bath was set to 80° C. The starch slurry was adjusted to pH 6.1-6.4 (the optimal pH of starch hydrolysis using Ban 480 L α-amylase). Ban 480 L amylase was weighed (0.15% of normal maize starch dry weight; 0.2% of waxy maize starch dry weight) and added to the slurry. The jar was placed in to the 80° C. water bath. After 1 h, the cooked starch viscosity was measured to check if the converted starch was at the desirable range (for example, <10 cp at 10% solid). If not, another 0.05% Ban 480 L was added to the slurry, and the cooked starch viscosity was checked again after another 15 min and 30 min. To measure the cooked starch viscosity, the slurry was cooked in a boiling water bath for 10 min, cooled to 25° C. and the cooked starch viscosity was measured at 25° C. by a Brookfield viscometer at 100 rpm. If the cooked starch viscosity was below the desirable range, the starch solution was put into a boiling water bath and heated at 95-100° C. for 10-15 min. After which, the slurry was cooled to room temperature. The converted starch was collected by spray drying (LPG-5 model; Jiangsu Fanqun Drying Equipment Factory, Jiangsu, China).

### Gel Permeation Chromatography (GPC)

Each sample (4 mg) was dissolved in 4 ml of dimethyl sulfoxide (DMSO) containing lithium bromide (0.5% w/w). The mixture was stirred in a boiling water bath for 24 h, cooled to room temperature, filtered through a 0.45 μm filter and then injected into a PL-GPC 220 instrument (Polymer Laboratories, Inc., Amherst, Mass., USA) equipped with three Phenogel columns and a guard column (Phenomenex, Inc., Torrance, Calif., USA). The eluent was DMSO containing 0.5% (w/w) LiBr, and the flow rate was 0.8 ml/min. Temperature was controlled at 80° C. Pullulan standards were used for universal calibration.

The results are shown in Table 1, below. “MC %” refers to moisture content as a weight percentage. “HP %” refers to hydroxypropyl group as a weight percentage. “DS” refers to the degree of PO substitution.

TABLE 1
Degraded PO starches

| | | | | | | Viscosity | Viscosity | MW Averages | | |
|---|---|---|---|---|---|---|---|---|---|---|
| No. | Material | Treatment | MC (%) | HP % | DS | (10% solids) | (5% solids) | Mn | Mw | PD |
| 1 | Normal | AC (3% HCl at 50° C. in 8 h) + | 8.09 | 2.16 | 0.056 | 80.0 cp | 20.0 cp | — | — | — |
| | corn | 5% PO (at 45° C.) | | | | | | | | |
| 2 | | AC (3% HCl at 50° C. in 8 h) + | 6.96 | 3.10 | 0.082 | 81.5 cp | 21.0 cp | — | — | — |
| | | 8% PO (at 45° C.) | | | | | | | | |
| 3 | | AC (3% HCl at 50° C. in 8 h) + | 7.53 | 4.55 | 0.117 | 97.0 cp | 24.0 cp | — | — | — |
| | | 10% PO (at 45° C.) | | | | | | | | |
| 4 | | 10% PO (at 50° C.) + AC (5% | 8.90 | 5.42 | 0.157 | 450.0 cp | 105.0 cp | — | — | — |
| | | HC1 at 40° C. in 10 h) | | | | | | | | |
| 5 | | AC (3% HCl at 50° C. in 12 h) + | 12.13 | 6.49 | 0.191 | 48.5 cp | 7.5 cp | — | — | — |
| | | 10% PO (at 50° C.) | | | | | | | | |
| 6 | | AC (3% HCl at 50° C. in 10 h) + | 9.94 | 6.88 | 0.203 | 88.5 cp | 13.0 cp | — | — | — |
| | | 10% PO (at 50° C.) | | | | | | | | |
| 7 | | AC (6% HCl at 50° C. in 6 h) + | 13.25 | 7.31 | 0.216 | 72.0 cp | — | 146789 | 657820 | 4.5 |
| | | 10% PO (at 50° C.) | | | | | | | | |
| 8 | | 10% PO (at 50° C.) + enzyme | 4.20 | 7.50 | 0.223 | 4.0 cp | — | 2891 | 51255 | 17.7 |
| | | (0.2% Ban480L at 80° C. in 1 h) | | | | | | | | |
| 9 | Waxy | AC (3% HCl at 50° C. in 12 h) + | 10.38 | 5.11 | 0.148 | 28.5 cp | 6.0 cp | — | — | — |
| | corn | 10% PO (at 43.5° C.) | | | | | | | | |
| 10 | | 10% PO (at 43.5° C.) + enzyme | 5.39 | 7.76 | 0.231 | 35.0 cp | 7.0 cp | — | — | — |
| | | (0.1% Ban480L at 80° C. in 2 h) | | | | | | | | |
| 11 | | 10% PO (at 43.5° C.) + enzyme | 4.43 | 7.37 | 0.219 | 4.0 cp | — | 3032 | 62538 | 20.6 |
| 12 | | (0.2% Ban480L at 80° C. in 1 h, | 4.96 | 7.34 | 0.218 | 5.0 cp | — | — | — | — |
| | | add extra 0.05% Ban480L in | | | | | | | | |
| | | 15 min) | | | | | | | | |
| 13 | | 10% PO (at 43.5° C.) + enzyme | 5.84 | 7.42 | 0.220 | 10.0 cp | — | 97878 | 322300 | 3.3 |
| 14 | | (0.2%Ban480L at 80° C. in 1 h, | 4.88 | 7.43 | 0.221 | 11.0 cp | — | 136447 | 408822 | 3.0 |
| | | add extra 0.05% Ban480L in | | | | | | | | |
| | | 15 min) | | | | | | | | |
| 15 | Ethylex ® | 10% PO at 45° C. | 9.98 | 5.91 | 0.172 | 61.5 cp | 9.0 cp | — | — | — |
| 16 | 2020 | 10% PO at 40° C. | 10.08 | 5.74 | 0.167 | 52.5 cp | 6.0 cp | — | — | — |

*Mn, number average molecular weight (MW); Mw, weight average MW; PD, polydispersity, Mw/Mn.

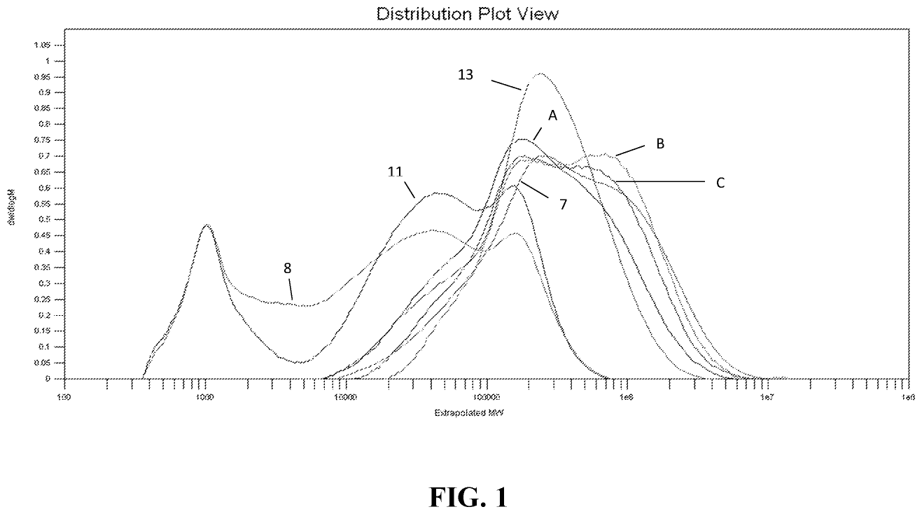

The molecular size distribution for various PO-modified starch samples in Table 1 is illustrated in FIG. 1. Starch A (Ethylex® 2020), Starch B (Ethylex® 2035), Starch C (Ethylex® 2025) are commercial starch samples manufactured by Tate & Lyle PLC and used herein as references for this plot.

I claim:

1. A method of modifying starch to form a degraded hydroxyalkylated starch comprising either:
(a) providing a degraded starch and then reacting the degraded starch with an alkylene oxide; or
(b) performing at least two sequential starch-modifying processes on a quantity of starch molecules,
wherein one of the processes comprises degrading the starch molecules into starch molecules having a lower molecular weight, and
wherein at least one other of the processes comprises reacting the starch molecules with an alkylene oxide.

2. The method of claim 1, wherein the process of degrading the starch molecules occurs prior to the process of reacting the starch molecules with the alkylene oxide.

3. The method of claim 1, wherein the process of reacting the starch molecules with the alkylene oxide occurs prior to the process of degrading the starch molecules.

4. The method of claim 1, wherein the process of degrading the starch molecules comprises reacting the starch molecules with an acid capable of hydrolyzing alpha-1,4 and alpha-1,6 glycosidic linkages within the starch molecules.

5. The method of claim 4, wherein the process of degrading the starch molecules comprises dispersing the starch molecules in an aqueous slurry followed by addition of the acid to the slurry.

6. The method of claim 5, wherein the temperature of the aqueous slurry during at least a portion of the process of degrading the starch is from about 25° C. to about 75° C.

7. The method of claim 5, wherein the acid is added to the aqueous slurry in an amount of from about 1.5% to about 7.5% by weight.

8. The method of claim 5, wherein the aqueous slurry has a solids content of from about 10% to about 70% by weight.

9. The method of claim 1, wherein the process comprises treating the starch molecules with an amylase enzyme capable of cleaving the starch molecules into starch molecules of a lower molecular weight.

10. The method of claim 9, wherein the amylase enzyme is α-amylase.

11. The method of claim 9, wherein the process of degrading the starch molecules comprises dispersing the starch molecules in an aqueous slurry followed by addition of the amylase enzyme.

12. The method of claim 11, wherein the temperature of the aqueous slurry during at least a portion of the process of degrading the starch is from about 65° C. to about 90° C.

13. The method of claim 11, wherein the pH of the aqueous slurry is adjusted, prior to the addition of the amylase enzyme, to be within a range in which the amylase enzyme is most effective in hydrolyzing glycoside linkages within the starch molecule.

14. The method of claim 13, wherein the pH of the aqueous slurry is adjusted to from 6.1 to 6.4.

15. The method of claim 11, wherein the process of degrading the starch is carried out until the aqueous slurry exhibits a cooked starch Brookfield viscosity at a spindle speed of 100 rpm of less than 10 cp at 25° C. and a solids level of 10% by weight.

16. The method of claim 1, wherein the process of reacting the starch molecules with the alkylene oxide comprises dispersing the starch molecules in an aqueous slurry, followed by the addition of from about 1% to about 25% by weight of sodium sulfate to the aqueous slurry, followed by adjusting the pH of the aqueous slurry to from about 10 to about 12, followed by the addition of from about 1% to about 25% by weight of the alkylene oxide to the aqueous slurry.

17. The method of claim 16, wherein the temperature of the aqueous slurry during at least a portion of the process of reacting the starch molecules with alkylene oxide is from about 25° C. to about 75° C.

18. The method of claim 16, wherein following reaction of the starch molecules with the alkylene oxide, the pH of the aqueous slurry is adjusted to about 4.5 to about 7 through the addition of an acid.

19. The method of claim 1, wherein starch to be modified is a waxy or non-waxy starch derived from wheat, maize, potato, tapioca, rice, sorghum, peas, or chickpeas.

20. The method of claim 19, wherein the starch to be modified is a waxy starch having an amylopectin content of greater than 50% by weight.

21. The method of claim 1, wherein following the process of reacting the starch molecules with the alkylene oxide, the method comprises drying the hydroxypropyl-substituted starch at a temperature of from about 35° C. to about 50° C.

22. The method of claim 1, wherein the alkylene oxide is selected from the group consisting of ethylene oxide, propylene oxide, and butylene oxide.

23. A modified starch produced by the method of claim 1.

24. A modified starch product comprising a degraded and hydroxyalkylated starch, wherein the starch has a degree of substitution of from about 0.05 to about 0.30, and wherein the starch, when dispersed in an aqueous slurry at a 10% solids content, has a cooked starch Brookfield viscosity at 25° C. and 100 rpm of from about 3 cp to about 100 cp.

25. The modified starch product of claim 24, wherein the starch has a number average molecular weight of from about 1,000 to about 150,000.

26. The modified starch product of claim 24, wherein the starch has a weight average molecular weight of from about 25,000 to about 750,000.

27. The modified starch product of claim 24, wherein the starch has a polydispersity of from about 1 to about 25.

28. The modified starch product of claim 24, wherein the starch comprises a hydroxypropylated starch.
